(19) United States
(12) Patent Application Publication
(10) Pub. No.: US 2009/0314186 A1
(43) Pub. Date: Dec. 24, 2009

(54) Retentive concrete material

(76) Inventor: Michael S. Rodgers, Madison, MS (US)

Correspondence Address: WILLIAM P. GLENN, JR.;ROYSTON, RAYZOR, VICKERY & WILLIAMS, L.L.P., 2102 MECHANIC STREET, SUITE 205, GALVESTON, TX, 77550, US

(21) Appl. No.: 11/659,912

(22) PCT Filed: Aug. 11, 2005
(86) PCT No.: PCT/US05/28447

§ 371 Date: Aug. 30, 2007

Related U.S. Application Data
(60) Provisional application No. 60/600,491, filed on Aug. 11, 2004.

(51) Int. Cl. C04B 28/08; C04B 28/04; C04B 28/02; C04B 14/06; C04B 14/00

(52) U.S. Cl. 106/706; 524/8; 524/2; 106/718; 106/721; 106/790

(57) ABSTRACT

A concrete material with fastener retentive qualities that can be varied to approximate the fastening holding characteristics of a selected variety of wood species or composite wood products comprising a mixture of cement binder, aggregate, and pliable material in the following volumetric ratio of approximately one-half (½) to one (1) part cement binder to approximately two (2) parts aggregate to approximately two (2) to five (5) parts pliable additive material. Cement binder can be Portland Cement, fly ash, slag and a combination thereof. Aggregate can be sand, gravel, stone, crushed rock, and a combination thereof. Pliable material can be plastic, cellulose, crumb rubber, and a combination thereof in pelletized, grannular or powdered form.

### TECHNICAL FIELD

This invention relates generally to concrete used in the construction industry. More particularly, it relates to an improved concrete material that can be uniformly shaped into building components capable of receiving and nails, screws, bolts, lag screws, drift pins, staples and metal connectors of various types.

### BACKGROUND ART

In general, concrete has been used to construct walls and other structural building components, such as slabs, panels, piers, columns and posts. However the construction of such components features require either on or off site construction.

Construction that requires walls or other building components, such as slabs, panels, piers, columns and posts are typically carried out through the use of large prefabricated modular concrete components or pouring a concrete slurry into a temporary form erected on site (e.g. pour-in-place). This temporary or removable form must be constructed to hold a concrete slurry in place until cured. A comprehensive network of supports must be temporarily constructed to support the temporary form. Thereafter the supports and removable forms are disassembled and removed from the construction site. Furthermore, in certain circumstances, the constructor/builder must make multiple pours to achieve the final building structure. Such multiple pours require repeated erection and dismantling of the temporary forms and support structures.

In contrast, prefabricated modular concrete components can be utilized to construct a building. Such prefabricated modular concrete components are typically poured (or formed), cured and stored offsite until required at the construction site. This construction approach presents the constructor/builder with unique challenges in lifting and moving the large prefabricated modular components to the final position at the construction site. The use of smaller prefabricated modular components formed and cured from non-slumping concrete mixes eliminates or at least reduces the reliance on cranes or other large material handling equipment.

In contrast to the pour-in-place and prefabricated modular methods of construction, a constructor/builder can erect a permanent form from a number of smaller, easier to manage pre-fabricated components. Such a method eliminates the transportation, erection and disassembly of forms; but still requires the use of removable support structures. One type of permanent form is an insulated concrete form (ICF) made from expanded polystyrene.

A polystyrene insulated concrete form (PICF) functions as a form to receive a concrete slurry. Once the concrete slurry cures and hardens the PICF functions as an external thermo-insulative cladding for the adjacent hardened concrete. However, a constructor/builder using an PICF system must be vigilant during the pour of a concrete slurry to prevent bursting the polystyrene or compromising the structural integrity of the concrete form.

Whether poured-in-place or constructed from pre-fabricated components (large or small), the constructor/builder is faced with the challenge of making an attachment to the concrete surface with penetrating attachment devices such as nails, spikes, screws, bolts, lag screws, drift pins, staples, rivets and metal connectors of various types (like metal plate connectors). Such penetrating attachment devices when driven into harden concrete typically are not retained and further cause cracking, and structural degradation of the structure or component. Similarly, the thermo-insulative cladding of a PICF is prone to tear outs when receiving a penetrating attachment device.

The insertion or placement of strips or studs of wood or metal at predetermined intervals on the concrete structure is a common solution for the inability of the concrete material itself to accept and retain penetrative devices. This insertion or placement of materials capable of receiving attachments can occur during the construction of the form (be it a removable or permanent form) or right before the pour is made. For example, when an ICF method of construction is used, attachment studs or strips can be incorporated into an individual ICF component (like a block or panel) as it is manufactured. In another example, an attachment stud or strip can be pre-positioned in a removable form prior to the pouring of the concrete slurry. With either solution, the ICF manufacturer, constructor/builder or architect must determine before construction where and how the attachment strips/studs must be placed. As can be appreciated, creating attachment regions after-the-fact require expensive work arounds or inferior/substandard attachment alternatives, such as gluing or other adhesive means.

Similarly, if conduits or utility ways are required, then the creation of conduits within the form or the concrete structure itself must be planned out and constructed before the concrete slurry is cured. This requires the constructor/builder and/or architect to plan ahead. As can be appreciated, additions after-the-fact require cutting the concrete or making work arounds, both of which are very expensive.

An improved concrete mixture is disclosed in U.S. Pat. Nos. 5,737,896 and 5,974,762. In both patents, a lightweight concrete mixture comprising a cement binder, sand, and polystyrene pellets is mixed and cured into a variety of shapes (blocks or panels) that exhibit thermo-insulative properties and some ability to receive penetrating devices. Because the improved concrete mix disclosed in U.S. Pat. Nos. 5,737,896 and 5,974,762 is lightweight, blocks (and other components) of substantially larger dimensions than common cinder blocks (or similar components) can be formed for a person to individually lift into position. As disclosed in U.S. Pat. Nos. 5,737,896 and 5,974,762, the lightweight concrete mix, once hardened, may be sawed by conventional means.

While the improved concrete mix, as disclosed in U.S. Pat. Nos. 5,737,896 and 5,974,762, overcomes the disadvantages of a traditional concrete mixes, the constructor/builder must take care in the size of a penetration attachment device; as well as the spacing or proximity of adjacent penetration attachment device points to avoid compromising the fastener retentive strength and/or structural integrity of the structure built.

In view of the above described deficiencies associated with concrete construction of buildings and other structures, the present invention has been developed to alleviate these drawbacks and provide further benefits to the user. These enhancements are benefits are described in greater detail below with respect to several alternative embodiments of the present invention.

### DISCLOSURE OF INVENTION

This invention includes features and components that have been invented and selected for their combined benefits and superior performance as an improved concrete capable of retaining penetrating fasteners, like nails, bolts, screws, or rivets. Each of the individual components work in association with the others and are optimally mated for superior performance.

Referring now to specific embodiments of the retentive concrete material and several of its applications in the building/construction industries, additional benefits and advantageous features will be appreciated. The present invention is directed at the formulation of a concrete mixture with pliable additives that, when hardened and/or cured, presents a uniformly mixed and hardened/cured concrete with fastener retentive qualities that can be varied to approximate the fastening holding characteristics of a selected variety of wood species or composite wood product (e.g. plywood, OSB, MDF or chip board). Such a retentive concrete material can be formed into a variety of shapes for use in the building construction industries.

It is contemplated that a retentive concrete material comprises a mixture of cement binder, aggregate, and pliable material in the following volumetric ratio of approximately one-half (½) to one (1) part cement binder to approximately two (2) parts aggregate to approximately two (2) to five (5) parts pliable additive material. The cement binder is selected from the group consisting of Portland cement, fly ash, slag, and a combination thereof. The pliable material is selected from the group consisting of plastics, cellulose, crumb rubber and a combination thereof. It is further contemplated that a plastic can be a solid or expanded material selected from the group consisting of polystyrene, ABS, polycarbonate, polyolefins (e.g. polypropylene and polyethylene), polyvinyl chloride, polyurethane, phenolic, urea-formaldehyde, epoxy and a combination thereof.

The amount of water added to the retentive concrete mixture described above depends on the consistency required to form and cure it into useful shapes. By thoroughly mixing a predetermined ratio of pelletized, granular or powdered pliable material with a slurry of cement binder, and aggregate, the retentive concrete mixture can be poured into a form and cured to create a shaped concrete structure. By thoroughly combining a predetermined ratio of palletized, granular or powdered pliable material with a cement binder, aggregate and water to make a no-slump mixture, the retentive concrete mix can be molded and cured into a shaped concrete structure. Regardless of the amount of water used, once cured, the individual constituents of the pliable material are uniformly interspersed and permanently fixed in a matrix of set concrete that is capable of accepting and retaining penetrating attachment devices such as nails, spikes, screws, bolts, lag screws, drift pins, staples and metal connectors or various combinations.

Among those benefits and improvements that have been disclosed, other objects and advantages of this invention will become apparent from the following description.

### BRIEF DESCRIPTION OF DRAWINGS

FIG. 1 depicts a retentive concrete material in a block form with a pliable material interspersed in a concrete matrix.

FIG. 2 depicts a method of making and forming a retentive concrete mixture.

FIG. 3 depicts another method of making and forming a retentive concrete mixture.

### BEST MODE FOR CARRYING OUT THE INVENTION

As required, detailed embodiments of the present invention are disclosed herein; however, it is to be understood that the disclosed embodiments are merely exemplary of the invention that may be embodied in various and alternative forms. The figures, if any, are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present invention.

Furthermore, elements may be recited as being “coupled”; this terminology's use anticipates elements being connected together in such a way that there may be other components interstitially located between the specified elements, and that the elements may be connected in fixed or movable relation one to the other.

The present invention comprises a retentive concrete material 10 that has been discovered to have unique characteristics and applications in its cured or hardened state. Furthermore, several particularly advantageous applications have also been discovered that permit the employment of the retentive concrete material 10 that are especially beneficial to the building and highway construction industry.

As previously described, it is known to add mix polystyrene pellets into a cement slurry to create a concrete material that is lightweight, exhibits thermo-insulative characteristics and is capable of receiving penetrating attachments 05 like nails, and screws. The present invention includes the discovery of a method of making a concrete mixture 60 by which a pre-determined volume of pelletized, granulated and/or powdered pliable material 20 selected from the group consisting of plastic 22, cellulose 24, crumb rubber 26 and a combination thereof is mixed with pre-determined volumes of aggregate 30, water 40, and cement binder 50, selected from the group consisting of Portland cement 52, fly ash 54 and a combination thereof. It also has been discovered that introduction of a pliable material 20 to traditional concrete mixes of cement binder 50, water 40 and aggregate 30 reduces cracking by at least 50% once the concrete mixture 60 is cured and hardened and subjected to bending or impact loads.

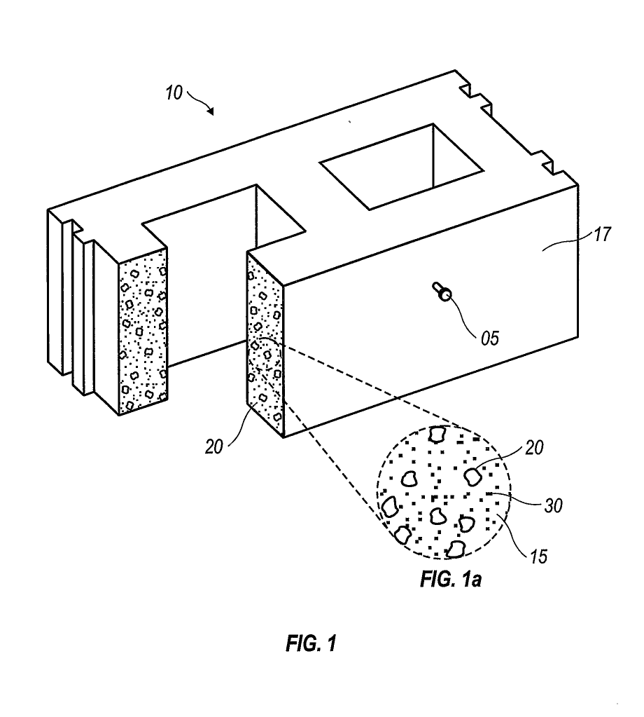

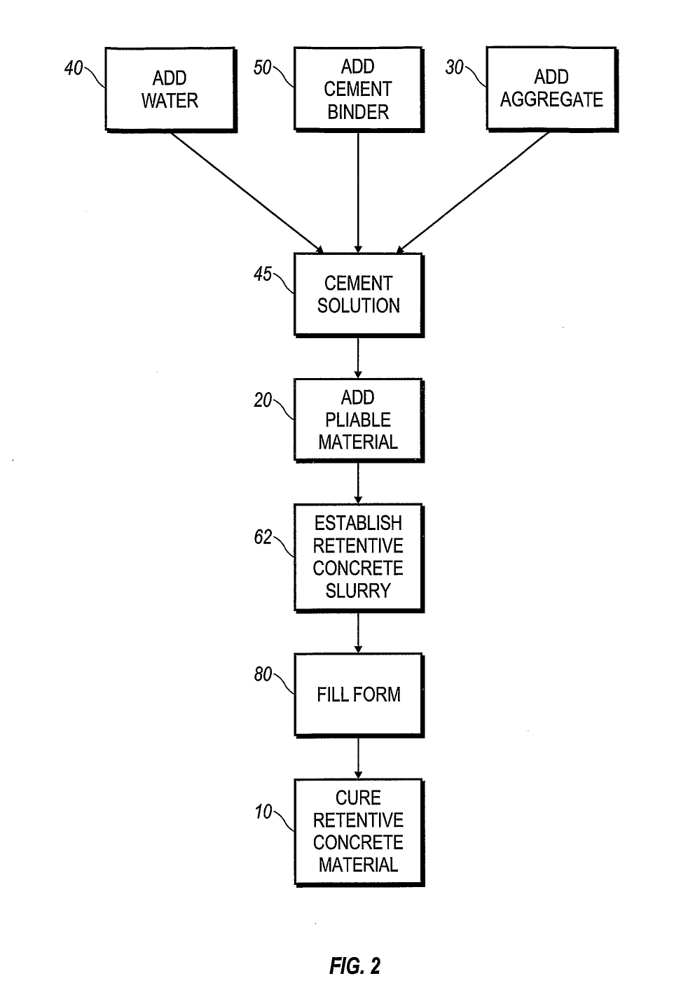

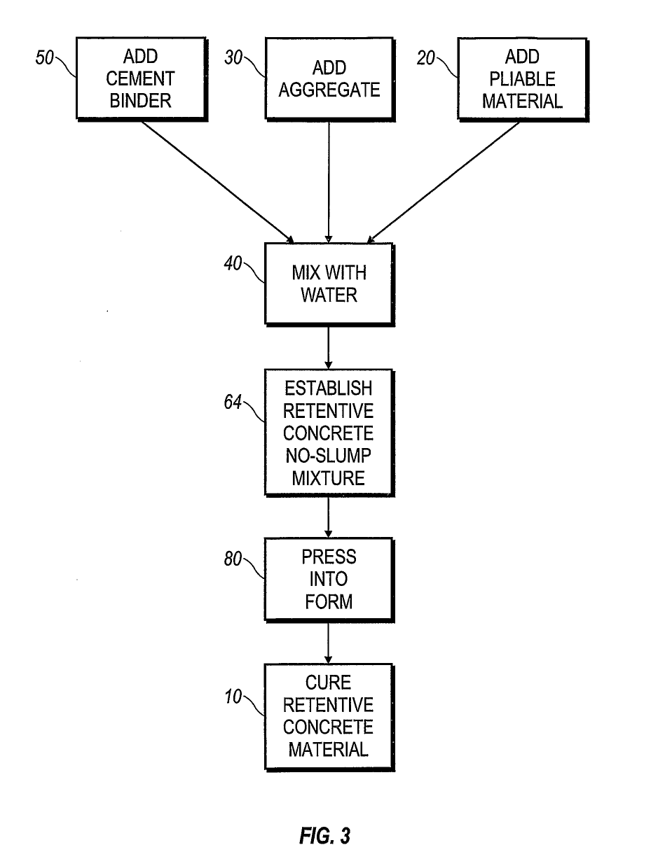

To achieve the advantageous qualities described herein, it has been discovered that a pliable material 20 mixed with aggregate 30, water 40 and cement binder 50 forms a concrete mixture 60 when cured and hardened, forms a retentive concrete material 10 capable of receiving and holding penetrating attachments 05 (like nails, spikes, screws, bolts, lag screws, drift pins, staples and metal connectors of various types) (FIG. 1) Mixing can be achieved through add-mixing pliable material 20 to a solution 45 of cement binder 50, water 40 and aggregate 30. (FIG. 2) The resulting slurry mixture 62 spreads to fill a form 80 (or a part thereof) and cures and hardens to form a shaped retentive concrete material 10. In another method, pliable material 20, aggregate 30 and cement binder 40 are dry mixed together with water 40 added to create a no-slump mixture 64 that is pressed into a form 80 (or a part thereof) to cure and hardened into a shaped concrete material 10. (FIG. 3)

It has been determined that the size of the polystyrene pellets add mixed into a cement solution, as disclosed in U.S. Pat. Nos. 5,737,896 and 5,974,762, while lightweight, presents polystyrene material in shapes that are too large in a cured concrete to hold or retain certain penetrating attachments. It has further been discovered that polystyrene pellets exposed at the improved concrete's surface(s) are susceptible to compaction and/or tear out during the placement, holding or removal of a penetrating attachment (like a nail or screw). Additionally, such exposed polystyrene pellets are likely to wear or be carried away by repeated contact from users or traffic (foot, vehicular or otherwise). Such compaction and tear outs make the surface of the concrete pitted and rough and further increase the likelihood of degrading the structural integrity of the improved concrete. The physical characteristics of pelletized polystyrene fixed in a concrete matrix causes the effects described above.

It has been discovered that a pelletized pliable material 20 with a higher durability than polystyrene or a pliable material 20 with an equal or lower durability than polystyrene formed into shapes smaller than a pellet as part of a concrete mixture 60 alleviates the compaction and tear out effects; and improves the retentive nature of the concrete and durability of the concrete's surface(s) 17. (FIG. 1) Furthermore, such a concrete mixture 60 once cured, exhibits a higher surface durability and retention of penetrating attachments 05 than the improved concrete mixture of U.S. Pat. Nos. 5,737,896 and 5,974,762.

Likewise, granulated or powdered pliable material 20 such as a solid plastic 221 or expanded plastic 222 (also known as closed cell plastic foam) as part of a concrete mixture 60 increases the amount of pliable material 20 in contact with the cement binder 50 of a concrete mixture 60. Once a concrete mixture 60 cures, the amount of pliable material 20 dispersed within a concrete matrix 15 is greater than the dispersion of polystyrene pellets set forth in improved concrete mixture of U.S. Pat. Nos. 5,737,896 and 5,974,762.(FIG. 1) This greater dispersion greatly reduces the creation and/or propagation of cracks from impact or bending stresses.

One method of making a retentive concrete material 10 includes combining approximately one-half (½) to one (1) volumetric part cement binder 50, approximately two (2) volumetric parts aggregate 30 and sufficient water 40 to make a concrete solution 45 with the consistency of cake batter. Approximately two (2) to five (5) volumetric parts pliable material 20 is add-mixed to concrete solution 45 to create a slurry 62 of the retentive concrete mixture 60. (FIG. 2)

Another embodiment of making a retentive concrete material 10 includes combining approximately one-half (½) to one (1) volumetric part cement binder 50, approximately two (2) volumetric parts aggregate 30 and approximately two (2) to five (5) volumetric parts pliable material 20 and adding water 40 to create a concrete mixture 60 in a non-slumping state 64. (FIG. 1)

It has been discovered that during mixing of a concrete mixture 60, pliable material 20 is coated with at least a portion of the cement binder 50 to render pliable material 20 at least fire resistant and in certain circumstances fire proof.

The cement binder 50 of a retentive concrete material 10 can be Portland cement 52, fly ash 54 or a combination thereof. The aggregate 30 of a retentive concrete material 10 can be sand 32, gravel 34 or stone 36. The pliable material 20 can be plastic 22, cellulose 24, crumb rubber 26 or a combination thereof.

In a preferred embodiment of the invention, equal volumes of Portland cement 52 and fly ash 54 comprise the cement binder 50. In another embodiment, the aggregate 30 can be naturally occurring sand 32, gravel 34, stone 36, crushed rock 38 or a combination thereof. A preferred embodiment incorporates the use of an aggregate that is fine or lightweight. It is also contemplated that normal or coarse aggregate 30 can be incorporated into the retentive cement material 10.

The pliable material 20 interspersed in the concrete matrix 15 can be solid plastics 221 from a virgin source or a recycling source. From recycling sources, plastics 221 can be recovered from carpet, plastic containers, plastic packaging and the like. Alternatively, pliable material 20 can be an expanded plastic 222 (also known as foamed plastic). Foamed or expanded plastic 222 can come from virgin or recycling sources. The size (powder, granules, and/or pellet) and porosity of plastic 22 has a greater impact upon the retentive qualities of a cured concrete slurry 60 than the type of material used (be it polystyrene, ABS, polycarbonate, polyolefins, polyvinylchloride, polyurethane, urea-formaldehyde, epoxy or a combination thereof). Furthermore, open versus closed pores or cells contributes to the retentive qualities of a concrete slurry 60 once hardened. It has been determined that plastic 22 with a closed cell foamed structure improves the retentive nature of a concrete slurry 60 once cured, and approximates the retentive nature of hardwoods. And use of the same type of plastic 22 but with an open cell foamed structure in a retentive concrete mixture 10 tends to approximate the retentive nature of softer woods. Furthermore, use of a plastic 22 with a closed cell structure reduces the amount of compaction and tear out as compared to the same plastic 22 with an open cell structure. As described above, the retentiveness of a retentive concrete material 10 and the durability of a concrete surface 17 can be the varied by the size (powder, granules, and/or pellet) and porosity of plastic 22 add mixed into a concrete slurry 60. Furthermore, the resistance to cracking of a retentive concrete material 10 can be varied by the size (powder, granules, and/or pellet) and type of plastic 22 that makes up a retentive concrete mixture 60.

In another embodiment, pliable material 20 uniformly dispersed through out a concrete matrix 15 may include cellulose 24. Cellulose 24 can be from virgin or recycled sources. In a preferred embodiment, cellulose 24 takes the form of wood pulp 241, saw dust 242 and/or shavings 243. In another embodiment, cellulose 24 takes the form of plant parts 243 from residential sources (like lawn clippings or flower bed refuse), agricultural sources (such as nutshells, cotton bowls, corn husks and cobs, and the like). The cellulose 24 as described above can be processed separately or in conjunction with a binder to render a powder, granular or pellet form. In a preferred embodiment, pliable material 20 is wood pulp 241 that has been produced from newspapers. In a preferred process of making a retentive concrete material 10, a retentive concrete mixture 60 includes approximately two (2) to five (5) volumes of pliable material 20 derived from wood pulp 241 produced from the wetting, macerating and partially drying of newspapers.

In another embodiment, pliable material 20 is crumb rubber 26. Crumb rubber 26 can be from virgin or recycled sources. A plentiful source of crumb rubber 26 is derived from old or used tires. If derived from old or used tires, it is contemplated that crumb rubber 26 may contain fibers 261 and/or steel 262. Similar to a pliable material 20 consisting of plastic 22, the size and shape of crumb rubber 26 of a retentive concrete material 10 varies the retentive quality and durability of a concrete surface 17. Unlike the crumb rubber added to a Portland cement as disclosed in U.S. Pat. No. 6,695,909, the present invention does not seek to replace entrained air to improve freeze/thaw characteristics. As described above, a pliable material 20, like crumb rubber 26 is interspersed in the concrete matrix 15 to approximate the retentive characteristics of a selected species of wood or composite wood product and/or vary the durability of a concrete surface 17. Furthermore, it has been discovered that the use of crumb rubber 26 with non-metallic fibers 261 or steel strands 262 from the processing of used or old tires, further enhances the ability of the retentive concrete material 10 to resist cracking from bending or impact stresses.

Forming of a retentive concrete mixture 60 utilizes traditional forming techniques. It is contemplated that a retentive concrete material 20 can be formed and cured into vertical and horizontal structures that comprise a building or similar structure (e.g. walls, floors, ceilings, roofs, and the like). It is further contemplated that a retentive concrete material 20 can be formed and cured into uniform and reproducible building components such as sheets, strips, panels, blocks, piers, beams, columns, railings, frames, decks, shingles, trusses, and tiles. Finally it is contemplated that a retentive concrete mixture 60 can be formed and cured into other civil engineered structures such as highways, bridges, runways and the like.

In one forming step, a form 70 is at least partially filled by a slurry 62 which holds the slurry 62 until cured and hardened into a shaped retentive concrete material 10. In another forming step, a non-slumping state 64 of concrete mixture 60 is formed into a desired shaped and allowed to cure and harden. (FIGS. 2 and 3) Whether in a slurry state 62 or non-slumping state 64, retentive concrete mixture 60 hardens and cures into a uniform dispersion of pliable material 20 throughout the concrete matrix 15.

These and other variations which will be appreciated by those skilled in the art are within the intended scope of this invention as claimed below. As previously stated, detailed embodiments of the present invention are disclosed herein; however, it is to be understood that the disclosed embodiments are merely exemplary of the invention that may be embodied in various forms.

What is claimed and desired to be secured by Letters Patent is as follows:

1. A concrete material capable of receiving and securely holding a penetrating attachment comprising:
a pliable material uniformly interspersed and fixed in a concrete matrix having a volumetric ratio of approximately two (2) to five (5) parts pliable material, approximately two (2) parts aggregate and approximately one-half (½) to one (1) parts cement binder;
said pliable material is selected from the group consisting of plastic, cellulose, crumb rubber and a combination thereof;
said aggregate is selected from the group consisting of sand, gravel, stone, crushed rock and a combination thereof; and
said cement binder is selected from the group consisting of Portland cement, fly ash, slag and a combination thereof.

2. A concrete material capable of receiving and securely holding a penetrating attachment as claimed in claim 1, wherein said pliable material comprises metallic strands.

3. A concrete material capable of receiving and securely holding a penetrating attachment as claimed in claim 1, wherein said pliable material comprises non-metallic fibers.

4. A method of making a concrete material comprising the steps of:
determining the retentive characteristic to be achieved;
creating a retentive concrete mixture comprising water, approximately one-half (½) to one (1) volumetric part cement binder, approximately two (2) volumetric parts aggregate and approximately two (2) to five (5) volumetric parts pliable material;
forming said retentive concrete mixture into a desired shape; and
curing said formed retentive concrete mixture into a shaped retentive concrete material.

5. A method of making a concrete material as claimed in claim 4, wherein said retentive concrete mixture is in the form of a slurry.

6. A method of making a concrete material as claimed in claim 4, wherein said retentive concrete mixture is in a non-slumping form.
